(19) United States
(12) Patent Application Publication
(10) Pub. No.: US 2025/0374218 A1
(43) Pub. Date: Dec. 4, 2025

(54) METHOD AND APPARATUS FOR CONFIGURING TIMING ADVANCE OFFSET

(71) Applicant: FUJITSU LIMITED, Kawasaki-shi (JP)

(72) Inventors: Meiyi JIA, Beijing (CN); Yujia SHAN, Beijing (CN)

(73) Assignee: FUJITSU LIMITED, Kawasaki-shi (JP)

(21) Appl. No.: 19/301,450

(22) Filed: Aug. 15, 2025

Related U.S. Application Data
(63) Continuation of application No. PCT/CN2023/076644, filed on Feb. 16, 2023.

(51) Int. Cl. H04W 56/00; H04W 48/16

(52) U.S. Cl. CPC H04W 56/0045; H04W 48/16

(57) ABSTRACT

An apparatus, configured in a network device, includes: a memory; processor circuitry coupled to the memory; and a transmitter configured to transmit first information to a terminal equipment, the first information being used for configuring a first parameter and a second parameter, the first parameter including a value of a first timing advance offset of a severing cell, the second parameter including a value of a second timing advance offset, and the serving cell being associated with the value of the first timing advance offset and the value of the second timing advance offset; wherein the first parameter or the first timing advance offset is associated with at least one of the following: a control resource set (CORESET); a timing advance group (TAG); and a physical cell identifier (PCI).

### CROSS-REFERENCE TO RELATED APPLICATION

This application is a continuation application under 35 U.S.C. 111 (a) of International Patent Application PCT/CN2023/076644 filed on Feb. 16, 2023, and designated the U.S., the entire contents of which are incorporated herein by reference.

### FIELD

The present disclosure relates to the field of communications.

### BACKGROUND

In existing uplink timing control mechanisms, a gNB determines an expected timing advance (TA) setting and provides it to a user equipment (UE). The UE uses the TA provided by the gNB to determine its uplink transmission time relative to a downlink receiving time observed by the UE, as shown in FIG. 1.

In existing multi-TRP (Transmit/Receive Point) operations, a serving cell may schedule a UE from two TRPs to provide better coverage, reliability and/or data rates of a PDSCH (Physical Downlink Shared Channel), a PDCCH (Physical Downlink Control Channel), a PUSCH (Physical Uplink Shared Channel) and a PUCCH (Physical Uplink Control Channel).

At present, there are two different operation modes to schedule multi-TRP PDSCH transmission: single-DCI (Downlink Control Information) and multi-DCI. For both modes, within a configuration provided by an RRC (Radio Resource Control) layer, control of uplink and downlink operations can be implemented by a physical layer and an MAC (Media Access Control) layer. In a single-DCI mode, a UE is scheduled by the same DCI for both TRPs, while in a multi-DCI mode, the UE is scheduled by independent DCIs from each TRP.

For an inter-cell multi-TRP operation, for multi-DCI PDSCH transmission, one or more TCI states can be associated with SSB (Synchronization Signal Blocks) with a PCI (Physical Cell Identifier) different from the serving cell PCI. An activated TCI state can be associated with at most one PCI different from the serving cell PCI at a time.

On the other hand, MIMO (Multiple-Input Multiple-Output) is one of the key technologies of a NR (New Radio/new air interface) system and has been successfully commercialized at present. Rel-15/16/17 (versions 15, 16, 17) study and define MIMO characteristics for FDD (Frequency Division Duplex/Duplexing) and TDD (Time Division Duplex/Duplexing) systems, the main part of which is a downlink MIMO operation.

Furthermore, beam-level mobility can be performed within a cell or between cells, the latter is called Inter-cell Beam Management (ICBM). For ICBM, the UE may receive or transmit a UE dedicated channel/signal via a TRP associated with a PCI different from a PCI of a serving cell. Meanwhile, a non-UE-dedicated channel/signal can only be received via a TRP associated with the PCI of the serving cell.

In Rel-18 (version 18), it is important to determine and define a necessary enhancement for uplink MIMO, in which two timing advances (TAs) are provided to promote uplink multi-TRP deployment, thus additional uplink performance enhancements may be provided. Goal is to study and define (if reasonable) two uplink TAs for a multi-DCI multi-TRP operation.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

The inventor finds that currently, for a multi-DCI multi-TRP operation with two TAs, at most two n-TimingAdvanceOffset values for each serving cell are supported. However, according to an existing mechanism, a network broadcasts one n-TimingAdvanceOffset value via IE ServingCellConfigCommonSIB in SIB1 (System Information Block 1). The network further only provides one terminal-specific n-TimingAdvanceOffset value for a served UE via IE ServingCellConfigCommon.

That is to say, the existing mechanism only supports one n-TimingAdvanceOffset value for each serving cell, then for the multi-DCI multi-TRP operation of two TAs under one serving cell, it is impossible to configure different n-TimingAdvanceOffset values for each TRP, which may cause the terminal to be out of sync on a UL (uplink) of at least one TRP. This will cause the network to fail to correctly receive UL transmission (uplink transmission) of this terminal and interfere with UL transmission of other terminals, thereby affecting user experience and reducing network throughput.

For at least one of the above problems or other similar problems, the embodiments of the present disclosure provide a method and an apparatus for configuring a timing advance offset.

According to an aspect of the embodiments of the present disclosure, an apparatus for configuring a timing advance offset is provided, configured in a network device, the apparatus comprising:
a transmitting unit configured to transmit first information to a terminal equipment, the first information being used for configuring a first parameter, the first parameter including values of one or two timing advance offsets of one serving cell, the serving cell being associated with values of two timing advance offsets.

According to another aspect of the embodiments of the present disclosure, an apparatus for determining a timing advance offset is provided, configured in a terminal equipment, the apparatus comprising:
a receiving unit configured to receive first information, the first information being used for configuring a first parameter, the first parameter including values of one or two timing advance offsets of one serving cell, the serving cell being associated with values of two timing advance offsets, and
a determining unit configured to determine a timing advance offset of uplink transmission according to the first parameter.

One of advantageous effects of the embodiments of the present disclosure lies in: according to the embodiments of the present disclosure, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or illustrated with respect to one implementation may be used in the same way or in a similar way in one or more other implementations and in combination with or instead of the features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings according to these drawings under the premise that they do not pay inventive labor. In the drawings:

FIG. 1 is a schematic diagram of a timing relationship between uplink and downlink;

FIG. 2 is a schematic diagram of an example of an application scenario of the embodiments of the present disclosure;

FIG. 3 is a schematic diagram of a method for configuring a timing advance offset in the embodiments of the present disclosure;

FIG. 4 is another schematic diagram of a method for determining a timing advance offset in the embodiments of the present disclosure;

FIG. 5 is a schematic diagram of an apparatus for configuring a timing advance offset in the embodiments of the present disclosure;

FIG. 6 is a schematic diagram of an apparatus for determining a timing advance offset in the embodiments of the present disclosure;

FIG. 7 is a schematic diagram of a terminal equipment in the embodiments of the present disclosure;

FIG. 8 is a schematic diagram of a network device in the embodiments of the present disclosure.

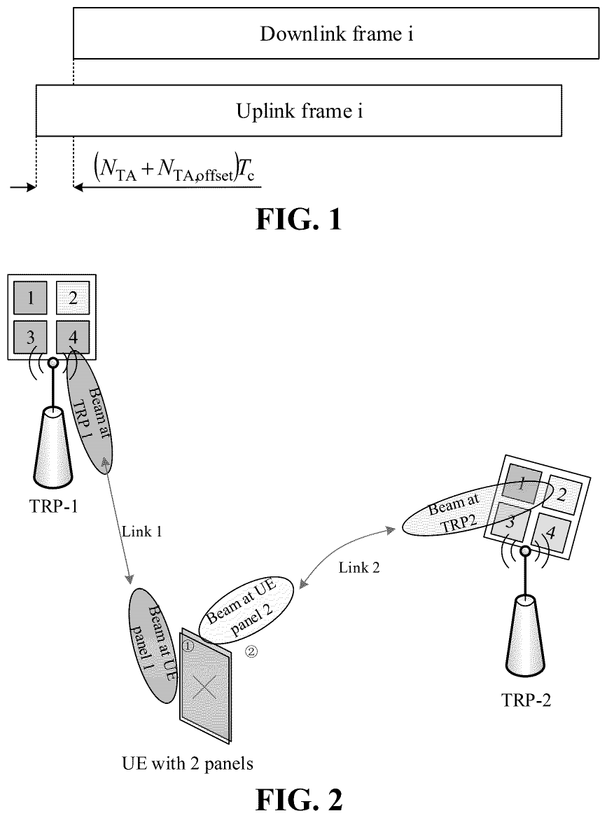

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA), New Radio (NR) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP) node, a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further includes a Remote Radio Head (RRH), a Remote Radio Unit (RRU), a relay or a low power node (such as femto, pico, etc.). And the term “base station” may include some or all functions of a base station, each base station may provide communication coverage to a specific geographic region. The term “cell” may refer to a base station and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera, or may be an IAB-MT, and so on.

For another example, under a scenario such as Internet of Things (IoT), the terminal equipment may also be a machine or apparatus for monitoring or measurement, for example may include but 5 be not limited to: a Machine Type Communication (MTC) terminal, a vehicle-mounted communication terminal, a Device to Device (D2D) terminal, a Machine to Machine (M2M) terminal and so on.

Currently, a network configuration respectively configures n-TimingAdvanceOffset applicable to random access on a serving cell and all uplink transmissions via a broadcasting or RRC-specific signaling configuration.

For example, IE ServingCellConfigCommonSIB (broadcast signaling) may include the

```
-- ASN1START
-- TAG-SERVINGCELLCONFIGCOMMONSIB-START
ServingCellConfigCommonSIB ::= SEQUENCE {
    downlinkConfigCommon DownlinkConfigCommonSIB,
    uplinkConfigCommon UplinkConfigCommonSIB
OPTIONAL, -- Need R
    supplementaryUplink UplinkConfigCommonSIB
OPTIONAL, -- Need R
    n-TimingAdvanceOffset ENUMERATED { n0, n25600, n39936 }
OPTIONAL, -- Need S
    ssb-PositionsInBurst SEQUENCE {
        inOneGroup BIT STRING (SIZE (8)),
        groupPresence BIT STRING (SIZE (8))
OPTIONAL -- Cond FR2-Only
    },
    ssb-PeriodicityServingCell ENUMERATED {ms5, ms10, ms20, ms40, ms80, ms160},
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    highSpeedConfig-r16 HighSpeedConfig-r16
OPTIONAL -- Need R
    ]],
    [[
    channelAccessMode2-r17 ENUMERATED {enabled}
OPTIONAL, -- Cond SharedSpectrum2
    discoveryBurstWindowLength-v1700 ENUMERATED {ms0dot125, ms0dot25, ms0dot5,
ms0dot75, ms1, ms1dot25} OPTIONAL, -- Need R
    highSpeedConfigFR2-r17 HighSpeedConfigFR2-r17
OPTIONAL, -- Need R
    uplinkConfigCommon-v1700 UplinkConfigCommonSIB-v1700
OPTIONAL -- Need R
    ]],
    [[
    enhancedMeasurementLEO-r17 ENUMERATED  {true}
OPTIONAL -- Need R
    ]]
}
-- TAG-SERVINGCELLCONFIGCOMMONSIB-STOP
-- ASN1STOP
```

Field descriptions of this IE ServingCellConfigCommonSIB may be as follows:

ServingCellConfigCommonSIB field descriptions

n-TimingAdvanceOffset
The N_TA-Offset to be applied for random access on this serving cell. If the field is absent,
the UE applies the value defined for the duplex mode and frequency range of this serving cell.
See TS 38.133 [14], table 7.1.2-2.

For another example, IE ServingCellConfigCommon (RRC signaling) may include the following content:

```
-- ASN1START
-- TAG-SERVINGCELLCONFIGCOMMON-START
ServingCellConfigCommon ::= SEQUENCE {
    physCellId PhysCellId
OPTIONAL,  -- Cond HOAndServCellAdd,
    downlinkConfigCommon DownlinkConfigCommon
OPTIONAL,  -- Cond HOAndServCellAdd
    uplinkConfigCommon UplinkConfigCommon
OPTIONAL,  -- Need M
    supplementaryUplinkConfig UplinkConfigCommon
OPTIONAL,  -- Need S
    n-TimingAdvanceOffset ENUMERATED { n0, n25600, n39936 }
OPTIONAL,  -- Need S
    ssb-PositionsInBurst CHOICE {
        shortBitmap BIT STRING (SIZE (4)),
        mediumBitmap BIT STRING (SIZE (8)),
        longBitmap BIT STRING (SIZE (64))
    }
OPTIONAL, -- Cond AbsFreqSSB
    ssb-periodicityServingCell ENUMERATED { ms5, ms10, ms20, ms40, ms80, ms160,
spare2, spare1 }  OPTIONAL, -- Need S
    dmrs-TypeA-Position ENUMERATED {pos2, pos3},
    lte-CRS-ToMatchAround SetupRelease { RateMatchPatternLTE-CRS }
OPTIONAL, -- Need M
    rateMatchPatternToAddModList SEQUENCE (SIZE (1..maxNrofRateMatchPatterns)) OF
RateMatchPattern  OPTIONAL, -- Need N
    rateMatchPatternToReleaseList SEQUENCE (SIZE (1..maxNrofRateMatchPatterns)) OF
Rate MatchPatternld OPTIONAL, -- Need N
    ssbSubcarrierSpacing SubcarrierSpacing
OPTIONAL, -- Cond HOAndServCellWithSSB
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    ssb-PositionQCL-r16 SSB-PositionQCL-Relation-r16
OPTIONAL, -- Cond SharedSpectrum
    highSpeedConfig-r16 HighSpeedConfig-r16
OPTIONAL -- Need R
    ]],
    [[
    highSpeedConfig-v1700 HighSpeedConfig-v1700
OPTIONAL, -- Need R
    channelAccessMode2-r17 ENUMERATED {enabled}
OPTIONAL, -- Cond SharedSpectrum2
    discoveryBurstWindowLength-r17 ENUMERATED {ms0dot125, ms0dot25, ms0dot5,
ms0dot75, ms1, ms1dot25} OPTIONAL, -- Need R
    ssb-PositionQCL-r17 SSB-PositionQCL-Relation-r17
OPTIONAL, -- Cond SharedSpectrum2
    highSpeedConfigFR2-r17 HighSpeedConfigFR2-r17
OPTIONAL, -- Need R
    uplinkConfigCommon-v1700 UplinkConfigCommon-v1700
OPTIONAL, -- Need R
    ntn-Config-r17 NTN-Config-r17
OPTIONAL -- Need R
    ]],
    [[
    featurePriorities-r17 SEQUENCE {
        redCapPriority-r17 FeaturePriority-r17
OPTIONAL, -- Need R
        slicingPriority-r17 FeaturePriority-r17
OPTIONAL, -- Need R
        msg3-Repetitions-Priority-r17 FeaturePriority-r17
OPTIONAL, -- Need R
        sdt-Priority-r17 Feature Priority-r17
OPTIONAL -- Need R
    }
OPTIONAL -- Need R
    ]]
}
```

Field descriptions of this IE ServingCellConfigCommon may be as follows:

```
ServingCellConfigCommon field descriptions
n-TimingAdvanceOffset
The N_TA-Offset to be applied for all uplink transmissions on this serving cell. If the field is
  absent, the UE applies the value defined for the duplex mode and frequency range of this
                serving cell. See TS 38.133 [14], table 7.1.2-2.
```

FIG. 2 is a schematic diagram of an example of an application scenario of the embodiments of the present disclosure. As shown in FIG. 2, this scenario involves a multi-DCI multi-TRP operation with two TAs, the TRP is a part of a gNB that receives signals from a terminal UE and/or transmits signals to a terminal UE. These two TRPs may belong to the same cell, or may belong to different cells. If these two TRPs belong to the same cell, it is called an intra-cell multi-DCI multi-TRP operation with two TAs. If these two TRPs belong to different cells, it is called an inter-cell multi-DCI multi-TRP operation with two TAs.

Various implementations of the present disclosure will be described below with reference to the drawings. These implementations are exemplary only and are not limitations to the present disclosure. In the following description, “if . . . ”, “in a case where . . . ” and “when . . . ”, etc. have the same meaning, and may be interchangeable. Furthermore, in the following description, “refer to . . . ” may further be replaced by “include . . . ” or “correspond to . . . ”.

### EMBODIMENTS OF A FIRST ASPECT

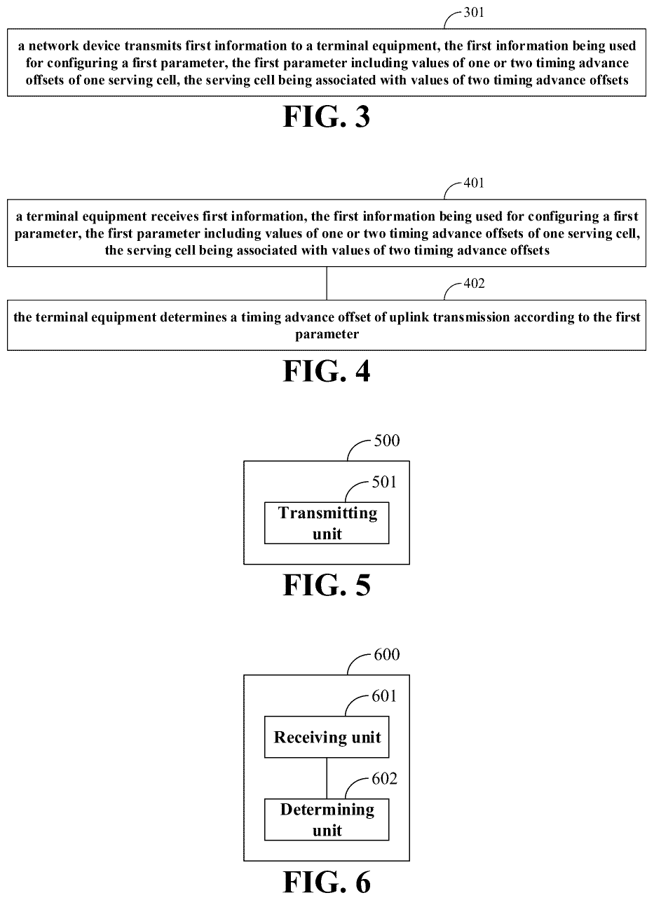

Embodiments of the present disclosure provide a method for configuring a timing advance offset, which is described from a network device side. FIG. 3 is a schematic diagram of a method for configuring a timing advance offset in the embodiments of the present disclosure. As shown in FIG. 3, the method includes:

301: a network device transmits first information to a terminal equipment, the first information being used for configuring a first parameter, the first parameter including values of one or two timing advance offsets of one serving cell, the serving cell being associated with values of two timing advance offsets.

It should be noted that the above FIG. 3 only schematically describes the embodiments of the present disclosure, but the present disclosure is not limited to this. For example, some other operations can be increased. Persons skilled in the art may make appropriate modifications according to the above contents, not limited to the records in the above FIG. 3.

According to the above embodiments, the network device configures values of one or two timing advance offsets via one parameter (a first parameter), so that a serving cell is associated with values of two timing advance offsets, that is, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

In some embodiments, the serving cell supports a multi-TRP, for example, supports two TRPs.

In the above embodiments, that the serving cell supports a multi-TRP may be that the serving cell is associated with at least one of the following:
multiple groups of downlink reference signals;
multiple groups of random access channel (RACH) resources;
multiple groups of random access (RA) preambles;
multiple control resource set pools (CORESETPools);
multiple timing advance groups (TAGs);
multiple physical cell identifiers (PCIs) different from a PCI of the serving cell.

For example, that the serving cell supports two TRPs may be that the serving cell is associated with two groups of downlink reference signals, or two groups of RACH resources, or two groups of RA preambles, or two CORESETPools, or two TAGs, or two PCIs different from a PCI of the serving cell, and so on.

For another example, each or each group of downlink reference signals is associated with one TRP, or each or each group of RACH resources is associated with one TRP, or each or each group of RA preambles is associated with one TRP, or each CORESET or each CORESETPool is associated with one TRP, or each TAG is associated with one TRP, or each or each group of PCIs that is different from a PCI of the serving cell is associated with one TRP, etc.

In the above embodiments, one of the multiple PCIs different from the PCI of the serving cell may be associated with at least one of the following:
one or a group of downlink reference signals;
one or a group of random access channel (RACH) resources;
one or a group of random access (RA) preambles;
a control resource set (CORESET);
a control resource set pool (CORESETPool); and
a timing advance group (TAG).

In some embodiments, “the first parameter includes a value of one timing advance offset of one serving cell” refers to that the first parameter includes a value of a first timing advance offset, and the first parameter or the first timing advance offset is associated with at least one of the following:
a group of downlink reference signals;
a group of random access channel (RACH) resources;
a group of random access (RA) preambles;
a control resource set pool (CORESETPool);
a control resource set (CORESET);
a timing advance group (TAG); and
a physical cell identifier (PCI) or a group of physical cell identifiers.

That is, the first parameter or the first timing advance offset is associated with one TRP.

In the above embodiments, “the first parameter or the first timing advance offset is associated with a group of downlink reference signals” refers to that information of the downlink reference signals and/or group information of the downlink reference signals is a part of the first parameter, i.e., the first parameter includes information of the downlink reference signals and/or group information of the downlink reference signals; or may further refer to that a configuration of the downlink reference signals or a configuration of the group of downlink reference signals (a configuration of a downlink reference signal group) includes or is associated with the first parameter or a value of the first timing advance offset.

For example, in an intra-cell scenario, the downlink reference signals may be grouped so that the first parameter or the first timing advance offset is associated with the downlink reference signal group. For another example, in an inter-cell scenario, the downlink reference signals are not grouped, under this scenario, the first parameter or the first timing advance offset may be associated with the downlink reference signals. The above text is just an example for illustration, the present application does not make limitations in this regard.

In the above embodiments, “the first parameter or the first timing advance offset is associated with a group of RACH resources” refers to that information of the RACH resources and/or group information of the RACH resources is a part of the first parameter, i.e., the first parameter includes information of the RACH resources and/or group information of the RACH resources; or may further refer to that a configuration of the RACH resources or a configuration of the group of RACH resources (a configuration of a RACH resource group) includes or is associated with the first parameter or a value of the first timing advance offset.

In the above embodiments, “the first parameter or the first timing advance offset is associated with a group of RA preambles” refers to that information of the RA preambles and/or group information of the RA preambles is a part of the first parameter, i.e., the first parameter includes information of the RA preambles and/or group information of the RA preambles; or may further refer to that a configuration of the RA preambles or a configuration of the group of RA preambles (a configuration of a RA preamble group) includes or is associated with the first parameter or a value of the first timing advance offset.

In the above embodiments, “the first parameter or the first timing advance offset is associated with one CORESETPool” refers to that information of the CORESETPool is a part of the first parameter, i.e., the first parameter includes information of the CORESETPool; or may further refer to that a configuration of the CORESETPool includes or is associated with the first parameter or a value of the first timing advance offset.

In a case of cross-TRP scheduling, that is, in a case where DCI and a PUSCH/PDSCH belong to different TRPs, additional information may be used for the above association. For example, an indication for cross-TRP scheduling is used to perform the above association.

In the above embodiments, “the first parameter or the first timing advance offset is associated with one CORESET” refers to that information of the CORESET is a part of the first parameter, i.e., the first parameter includes information of the CORESET; or may further refer to that a configuration of the CORESET includes or is associated with the first parameter or a value of the first timing advance offset.

In the above embodiments, “the first parameter or the first timing advance offset is associated with one TAG” refers to that ID of the TAG is a part of the first parameter, i.e., the first parameter includes ID of the TAG; or may further refer to that a configuration of the TAG includes or is associated with the first parameter or a value of the first timing advance offset.

In the above embodiments, “the first parameter or the first timing advance offset is associated with a PCI or a group of PCIs” refers to that the PCI is a part of the first parameter, i.e., the first parameter includes the PCI; or may further refer to that a configuration of a synchronization signal block (SSB) associated with the PCI or a configuration of the PCI includes or is associated with the first parameter or a value of the first timing advance offset.

In the above embodiments, the first parameter only includes a value of one timing advance offset of a serving cell, and a value of another timing advance offset may be indicated or provided by another parameter. For example, the first information may further configure a second parameter, the second parameter including a value of a second timing advance offset, and the second parameter or the second timing advance offset may be associated with at least one of the following:
a group of downlink reference signals that are default or not associated with the first parameter;
a group of random access channel (RACH) resources that are default or not associated with the first parameter;
a group of random access (RA) preambles that are default or not associated with the first parameter;
a control resource set pool (CORESETPool) that is default or not associated with the first parameter;
a control resource set (CORESET) that is default or not associated with the first parameter;
a timing advance group (TAG) that is default or not associated with the first parameter; and
a physical cell identifier (PCI) or a group of PCIs that is/are default or not associated with the first parameter.

That is, the second parameter or the second timing advance offset is associated with one TRP, and the TRP is different from a TRP associated with the first parameter or the first timing advance offset. For example, suppose that the first parameter or the first timing advance offset is associated with TRP1, the second parameter or the second timing advance offset is associated with TRP2.

In the above embodiments, the second parameter e.g. is n-TimingAdvanceOffset. As for its specific implementation, relevant technologies may be referred to, and a description thereof is omitted here.

In the above embodiments, “the first parameter includes a value of one timing advance offset of one serving cell, the serving cell being associated with values of two timing advance offsets” refers to that the first parameter includes a value of a first timing advance offset, the second parameter includes a value of a second timing advance offset, the serving cell is associated with the value of the first timing advance offset and the value of the second timing advance offset.

In some embodiments, “the first parameter includes values of two timing advance offsets of one serving cell” refers to that the first parameter includes a value of a first timing advance offset and a value of a second timing advance offset, and the first parameter is associated with at least one of the following, or the first timing advance offset and the second timing advance offset are associated with at least one of the following:
two groups of downlink reference signals;
two groups of random access channel (RACH) resources;
two groups of random access (RA) preambles;
two control resource set pools (CORESETPools);
two control resource sets (CORESETs);
two timing advance groups (TAGs); and
two or two groups of physical cell identifiers (PCIs).

In the above embodiments, the first timing advance offset and the second timing advance offset are respectively associated with a group of downlink reference signals; and/or a group of RACH resources; and/or a group of RA preambles; and/or one CORESETPool; and/or one CORESET; and/or one TAG; and/or a PCI or a group of PCIs. Specific method for association is similar to the aforementioned method for association.

For example, “the first parameter, or the first timing advance offset and the second timing advance offset is/are associated with two groups of downlink reference signals” refers to that information of the downlink reference signals and/or group information of the downlink reference signals is a part of the first parameter; or, a configuration of the downlink reference signals or a configuration of the group of downlink reference signals includes or is associated with the first parameter or includes or is associated with a value of the first timing offset and a value of the second timing advance offset.

For another example, “the first parameter, or the first timing advance offset and the second timing advance offset is/are associated with two groups of RACH resources” refers to that information of the RACH resources and/or group information of the RACH resources is a part of the first parameter; or, a configuration of the RACH resources or a configuration of the group of RACH resources includes or is associated with the first parameter or includes or is associated with a value of the first timing offset and a value of the second timing advance offset.

For another example, “the first parameter, or the first timing advance offset and the second timing advance offset is/are associated with two groups of RA preambles” refers to that information of the RA preambles and/or group information of the RA preambles is a part of the first parameter; or, a configuration of the RA preambles or a configuration of the group of RA preambles includes or is associated with the first parameter or includes or is associated with a value of the first timing offset and a value of the second timing advance offset.

For another example, “the first parameter, or the first timing advance offset and the second timing advance offset is/are associated with two CORESETPools” refers to that information of the CORESETPools is a part of the first parameter; or, a configuration of the CORESETPools includes or is associated with the first parameter or includes or is associated with a value of the first timing offset and a value of the second timing advance offset.

For another example, “the first parameter, or the first timing advance offset and the second timing advance offset is/are associated with two CORESETs” refers to that information of the CORESETs is a part of the first parameter; or, a configuration of the CORESETs includes or is associated with the first parameter or includes or is associated with a value of the first timing offset and a value of the second timing advance offset.

For another example, “the first parameter, or the first timing advance offset and the second timing advance offset is/are associated with two TAGs” refers to that ID of the TAGs is a part of the first parameter; or, a configuration of the TAGs includes or is associated with the first parameter or includes or is associated with a value of the first timing offset and a value of the second timing advance offset.

For another example, “the first parameter, or the first timing advance offset and the second timing advance offset is/are associated with two PCIs” refers to that PCIs are a part of the first parameter; or, a configuration of a synchronization signal block (SSB) or an additional PCI configuration includes or is associated with the first parameter or includes or is associated with a value of the first timing offset and a value of the second timing advance offset.

In the above embodiments, “the first parameter includes values of two timing advance offsets of one serving cell, the serving cell being associated with values of two timing advance offsets” refers to that the first parameter includes a value of a first timing advance offset and a value of a second timing advance offset, the serving cell is associated with the value of the first timing advance offset and the value of the second timing advance offset.

In the embodiments of the present disclosure, there are no restrictions on an implementation method of the first information. For example, the first information may be broadcast signaling or may be RRC dedicated signaling. That is, a network device may configure the first parameter via the broadcast signaling or the RRC dedicated signaling.

For example, the broadcast signaling may be SIB1, the first parameter is included in an information element ServingCellConfigCommonSIB of SIB1, as a field of the information element. For another example, the RRC dedicated signaling may be RRCReconfiguration, the first parameter is included in an information element ServingCellConfigCommon of the RRCReconfiguration, as a field of the information element.

The method in the embodiments of the present disclosure is described below respectively by taking “configuring the first parameter via broadcast signaling or RRC dedicated signaling” as an example.

“A network device configures the first parameter via broadcast signaling” is taken as an example.

In some embodiments, the first parameter includes a value of one timing advance offset of one serving cell, so that the serving cell is associated with values of two timing advance offsets (value of another timing advance offset may be provided via an existing parameter such as the second parameter mentioned above).

According to the above embodiments, descriptions of IE “ServingCellConfigCommonSIB” in the Standard may be modified, for example descriptions of said IE may be modified as:

```
-- ASN1START
-- TAG-SERVINGCELLCONFIGCOMMONSIB-START
ServingCellConfigCommonSIB ::= SEQUENCE {
    downlinkConfigCommon DownlinkConfigCommonSIB,
    uplinkConfigCommon UplinkConfigCommonSIB
OPTIONAL, -- Need R
    supplementaryUplink UplinkConfigCommonSIB
OPTIONAL, -- Need R
    n-TimingAdvanceOffset ENUMERATED { n0, n25600, n39936 }
OPTIONAL, -- Need S
    n-TimingAdvanceOffset_TRP SEQUENCE {
        n-TimingAdvanceOffset ENUMERATED { n0, n25600, n39936 }
    TRP_info TAG-Id,
    } OPTIONAL, -- Need S
    ssb-PositionsInBurst SEQUENCE {
        inOneGroup BIT STRING (SIZE (8)),
        groupPresence BIT STRING (SIZE (8))
OPTIONAL -- Cond FR2-Only
    },
    ssb-PeriodicityServingCell ENUMERATED {ms5, ms10, ms20, ms40, ms80, ms160},
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    highSpeedConfig-r16 HighSpeedConfig-r16
OPTIONAL -- Need R
    ]],
    [[
    channelAccessMode2-r17 ENUMERATED {enabled}
OPTIONAL, -- Cond SharedSpectrum2
    discoveryBurstWindowLength-v1700 ENUMERATED {ms0dot125, ms0dot25, ms0dot5,
ms0dot75, ms1, ms1dot25} OPTIONAL, -- Need R
    highSpeedConfigFR2-r17 HighSpeedConfigFR2-r17
OPTIONAL, -- Need R
    uplinkConfigCommon-v1700 UplinkConfigCommonSIB-v1700
OPTIONAL -- Need R
    ]],
    [[
    enhancedMeasurementLEO-r17 ENUMERATED {true}
OPTIONAL -- Need R
    ]]
}
-- TAG-SERVINGCELLCONFIGCOMMONSIB-STOP
-- ASN1STOP
```

In the above embodiments, field description of said IE may further be modified as follows:

ServingCellConfigCommonSIB field descriptions

n-TimingAdvanceOffset
The N_TA-Offset to be applied for random access on this serving cell. If the field is absent,
the UE applies the value defined for the duplex mode and frequency range of this serving cell.
See TS 38.133 [14], table 7.1.2-2. If is n-TimingAdvanceOffset_TRP is configured, the N_TA-
Offset to be applied for random access on the TAG not indicated by n-
TimingAdvanceOffset_TRP of this serving cell.
n-TimingAdvanceOffset_TRP
The N_TA-Offset to be applied for random access on the indicated TAG of this serving cell. If
the field is absent, the UE applies the value defined for the duplex mode and frequency range
of this serving cell. See TS 38.133 [14], table 7.1.2-2.

In the above embodiments, TRP_info uses TAG_Id as an identifier, and according to the embodiments of the present disclosure, a downlink reference signal (group)/an RACH resource (group)/an RA preamble (group)/a CORESET/a CORESETPool/a PCI (group) information different from a PCI of a serving cell, etc. may be further used.

According to the above embodiments, descriptions of IE “TAG-Config” in the Standard may further be modified, for example descriptions of said IE may be modified as:

```
-- ASN1START
-- TAG-TAG-CONFIG-START
TAG-Config ::= SEQUENCE {
    tag-ToReleaseList SEQUENCE (SIZE (1..maxNrofTAGs)) OF TAG-Id
OPTIONAL,  -- Need N
    tag-ToAddModList SEQUENCE (SIZE (1..maxNrofTAGs)) OF TAG
OPTIONAL  -- Need N
}
TAG ::= SEQUENCE {
    tag-Id TAG-Id,
    timeAlignmentTimer TimeAlignmentTimer,
    n-TimingAdvanceOffset_TRP ENUMERATED { n0, n25600, n39936 }
        OPTIONAL, -- Need S
...
}
TAG-Id ::= INTEGER (0..maxNrofTAGs-1)
-- TAG-TAG-CONFIG-STOP
-- ASN1STOP
```

In some other embodiments, the first parameter includes values of two timing advance offset of one serving cell, so that this serving cell is associated with values of two timing advance offsets.

According to the above embodiments, descriptions of IE “ServingCellConfigCommonSIB” in the Standard may be modified, for example descriptions of said IE may be modified as:

```
-- ASN1START
-- TAG-SERVINGCELLCONFIGCOMMONSIB-START
ServingCellConfigCommonSIB ::= SEQUENCE {
    downlinkConfigCommon DownlinkConfigCommonSIB,
    uplinkConfigCommon UplinkConfigCommonSIB
OPTIONAL, -- Need R
    supplementaryUplink UplinkConfigCommonSIB
OPTIONAL, -- Need R
    n-TimingAdvanceOffset ENUMERATED { n0, n25600, n39936 }
OPTIONAL, -- Need S
    n-TimingAdvanceOffset_TRP SEQUENCE (SIZE (1..2)) OF N-TA-ffset_TRP
    OPTIONAL, -- Need S
    N-TA-ffset_TRP SEQUENCE {
        n-TimingAdvanceOffset1 ENUMERATED { n0, n25600, n39936 }
    TRP_info TAG-Id,
    }
ssb-PositionsInBurst SEQUENCE {
        inOneGroup BIT STRING (SIZE (8)),
        groupPresence BIT STRING (SIZE (8))
OPTIONAL -- Cond FR2-Only
    },
    ssb-PeriodicityServingCell ENUMERATED {ms5, ms10, ms20, ms40, ms80, ms160},
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    highSpeedConfig-r16 HighSpeedConfig-r16
OPTIONAL -- Need R
    ]],
    [[
    channelAccessMode2-r17 ENUMERATED {enabled}
OPTIONAL, -- Cond SharedSpectrum2
    discoveryBurstWindowLength-v1700 ENUMERATED {ms0dot125, ms0dot25, ms0dot5,
ms0dot75, ms1, ms1dot25} OPTIONAL, -- Need R
    highSpeedConfigFR2-r17 HighSpeedConfigFR2-r17
OPTIONAL, -- Need R
    uplinkConfigCommon-v1700 UplinkConfigCommonSIB-v1700
OPTIONAL -- Need R
    ]],
    [[
    enhancedMeasurementLEO-r17 ENUMERATED {true}
OPTIONAL -- Need R
    ]]
}
-- TAG-SERVINGCELLCONFIGCOMMONSIB-STOP
-- ASN1STOP
```

In the above embodiments, field description of said IE may further be modified as follows:

ServingCellConfigCommonSIB field descriptions

n-TimingAdvanceOffset
The N_TA-Offset to be applied for random access on this serving cell. If the field is absent,
the UE applies the value defined for the duplex mode and frequency range of this serving cell.
See TS 38.133 [14], table 7.1.2-2. If is n-TimingAdvanceOffset_TRP is configured, the UE
ignores this field.
n-TimingAdvanceOffset_TRP
The N_TA-Offset to be applied for random access on the indicated TAG of this serving cell. If
the field is absent, the UE applies the value defined for the duplex mode and frequency range
of this serving cell. See TS 38.133 [14], table 7.1.2-2.

“A network device configures the first parameter via RRC dedicated signaling” is taken as an example.

In some embodiments, the first parameter includes a value of one timing advance offset of one serving cell, so that this serving cell is associated with values of two timing advance offsets (value of another timing advance offset may be provided via an existing parameter such as the second parameter mentioned above).

According to the above embodiments, descriptions of IE “ServingCellConfigCommon” in the Standard may be modified, for example descriptions of said IE may be modified as:

```
-- ASN1START
-- TAG-SERVINGCELLCONFIGCOMMON-START
ServingCellConfigCommon ::= SEQUENCE {
    physCellId PhysCellId
OPTIONAL,  -- Cond HOAndServCellAdd,
    downlinkConfigCommon DownlinkConfigCommon
OPTIONAL,  -- Cond HOAndServCellAdd
    uplinkConfigCommon UplinkConfigCommon
OPTIONAL,  -- Need M
    supplementaryUplinkConfig UplinkConfigCommon
OPTIONAL,  -- Need S
    n-TimingAdvanceOffset ENUMERATED { n0, n25600, n39936 }
OPTIONAL,  -- Need S
    n-TimingAdvanceOffset_TRP SEQUENCE {
        n-TimingAdvanceOffset ENUMERATED { n0, n25600, n39936 }
    TRP_info TAG-Id,
    } OPTIONAL, -- Need S
ssb-PositionsInBurst CHOICE {
        shortBitmap BIT STRING (SIZE (4)),
        mediumBitmap BIT STRING (SIZE (8)),
        longBitmap BIT STRING (SIZE (64))
    }
OPTIONAL, -- Cond AbsFreqSSB
    ssb-periodicityServingCell ENUMERATED { ms5, ms10, ms20, ms40, ms80, ms160, spare2,
spare1 } OPTIONAL, -- Need S
    dmrs-TypeA-Position ENUMERATED {pos2, pos3},
    lte-CRS-ToMatchAround SetupRelease { RateMatchPatternLTE-CRS }
OPTIONAL, -- Need M
    rateMatchPatternToAddModList SEQUENCE (SIZE (1..maxNrofRateMatchPatterns)) OF
RateMatchPattern  OPTIONAL, -- Need N
    rateMatchPatternToReleaseList SEQUENCE (SIZE (1..maxNrofRateMatchPatterns)) OF
RateMatchPatternId OPTIONAL, -- Need N
    ssbSubcarrierSpacing SubcarrierSpacing
OPTIONAL, -- Cond HOAndServCellWithSSB
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    ssb-PositionQCL-r16 SSB-PositionQCL-Relation-r16
OPTIONAL, -- Cond SharedSpectrum
    highSpeedConfig-r16 HighSpeedConfig-r16
OPTIONAL -- Need R
    ]],
    [[
    highSpeedConfig-v1700 HighSpeedConfig-v1700
OPTIONAL, -- Need R
    channelAccessMode2-r17 ENUMERATED {enabled}
OPTIONAL, -- Cond SharedSpectrum2
    discoveryBurstWindowLength-r17 ENUMERATED {ms0dot125, ms0dot25, ms0dot5,
ms0dot75, ms1, ms1dot25} OPTIONAL, -- Need R
    ssb-PositionQCL-r17 SSB-PositionQCL-Relation-r17
OPTIONAL, -- Cond SharedSpectrum2
    highSpeedConfigFR2-r17 HighSpeedConfigFR2-r17
OPTIONAL, -- Need R
    uplinkConfigCommon-v1700 UplinkConfigCommon-v1700
OPTIONAL, -- Need R
    ntn-Config-r17 NTN-Config-r17
OPTIONAL -- Need R
    ]],
    [[
    featurePriorities-r17 SEQUENCE {
        redCapPriority-r17 FeaturePriority-r17
OPTIONAL, -- Need R
        slicingPriority-r17 FeaturePriority-r17
OPTIONAL, -- Need R
        msg3-Repetitions-Priority-r17 FeaturePriority-r17
OPTIONAL, -- Need R
        sdt-Priority-r17 FeaturePriority-r17
OPTIONAL -- Need R
    }
OPTIONAL -- Need R
    ]]
}
-- TAG-SERVINGCELLCONFIGCOMMON-STOP
-- ASN1STOP
```

In the above embodiments, field description of said IE may further be modified as follows:

ServingCellConfigCommon field descriptions

n-TimingAdvanceOffset
The N_TA-Offset to be applied for all uplink transmissions on this serving cell. If the field is
absent, the UE applies the value defined for the duplex mode and frequency range of this
serving cell. See TS 38.133 [14], table 7.1.2-2. If is n-TimingAdvanceOffset_TRP is
configured, the N_TA-Offset to be applied for all uplink transmissions on the TAG not
indicated by n-TimingAdvanceOffset_TRP of this serving cell.
n-TimingAdvanceOffset_TRP
The N_TA-Offset to be applied for all uplink transmission on the indicated TAG of this
serving cell. If the field is absent, the UE applies the value defined for the duplex mode and
frequency range of this serving cell. See TS 38.133 [14], table 7.1.2-2.

In the above embodiments, TRP_info uses TAG_Id as an identifier, and according to the embodiments of the present disclosure, a downlink reference signal (group)/an RACH resource (group)/an RA preamble (group)/a CORESET/a CORESETPool/a PCI (group) information different from a PCI of a serving cell, etc. may be further used.

According to the above embodiments, descriptions of IE “TAG-Config” in the Standard may further be modified, for example descriptions of said IE may be modified as:

```
-- ASN1START
-- TAG-TAG-CONFIG-START
TAG-Config ::= SEQUENCE {
    tag-ToReleaseList SEQUENCE (SIZE (1..maxNrofTAGs)) OF TAG-Id
OPTIONAL,  -- Need N
    tag-ToAddModList SEQUENCE (SIZE (1..maxNrofTAGs)) OF TAG
OPTIONAL  -- Need N
}
TAG ::= SEQUENCE {
    tag-Id TAG-Id,
    timeAlignmentTimer TimeAlignmentTimer,
    n-TimingAdvanceOffset_TRP ENUMERATED { n0, n25600, n39936 }
        OPTIONAL, -- Need S
...
}
TAG-Id ::= INTEGER (0..maxNrofTAGs-1)
-- TAG-TAG-CONFIG-STOP
-- ASN1STOP
```

In the above embodiments, field description of said IE may further be modified as follows:

TAG field descriptions

tag-Id
Indicates the TAG of the SpCell or an SCell, see TS 38.321 [3]. Uniquely identifies the TAG
within the scope of a Cell Group (i.e. MCG or SCG).
timeAlignmentTimer
The timeAlignmentTimer for TAG with ID tag-Id, as specified in TS 38.321 [3].
n-TimingAdvanceOffset_TRP
The N_TA-Offset to be applied for random access on the indicated TAG of this serving cell. If
the field is absent, the UE applies the value defined for the duplex mode and frequency range
of this serving cell. See TS 38.133 [14], table 7.1.2-2.

In the above embodiments, the value of the timing advance offset is included in TAG configuration. According to the embodiments of the present disclosure, the value of the timing advance offset may further be included in a configuration of a downlink reference signal (group)/an RACH resource (group)/an RA preamble (group)/a CORESET/a CORESETPool/a PCI (group) different from a PCI of a serving cell, etc.

In some other embodiments, the first parameter includes values of two timing advance offset of one serving cell, so that this serving cell is associated with values of two timing advance offsets.

According to the above embodiments, descriptions of IE “ServingCellConfigCommon” in the Standard may be modified, for example descriptions of said IE may be modified as:

```
-- ASN1START
-- TAG-SERVINGCELLCONFIGCOMMON-START
ServingCellConfigCommon ::= SEQUENCE {
    physCellId PhysCellId
OPTIONAL,  -- Cond HOAndServCellAdd,
    downlinkConfigCommon DownlinkConfigCommon
OPTIONAL,  -- Cond HOAndServCellAdd
    uplinkConfigCommon UplinkConfigCommon
OPTIONAL,  -- Need M
    supplementaryUplinkConfig UplinkConfigCommon
OPTIONAL,  -- Need S
    n-TimingAdvanceOffset ENUMERATED { n0, n25600, n39936 }
OPTIONAL,  -- Need S
    n-TimingAdvanceOffset_TRP SEQUENCE (SIZE (1..2)) OF N-TA-ffset_TRP
    OPTIONAL, -- Need S
    N-TA-ffset_TRP SEQUENCE {
        n-TimingAdvanceOffset1 ENUMERATED { n0, n25600, n39936 }
    TRP_info TAG-Id,
    }
ssb-PositionsInBurst CHOICE {
        shortBitmap BIT STRING (SIZE (4)),
        mediumBitmap BIT STRING (SIZE (8)),
        longBitmap BIT STRING (SIZE (64))
    }
OPTIONAL, -- Cond AbsFreqSSB
    ssb-periodicityServingCell ENUMERATED { ms5, ms10, ms20, ms40, ms80, ms160, spare2,
spare1 } OPTIONAL, -- Need S
    dmrs-TypeA-Position ENUMERATED {pos2, pos3},
    lte-CRS-ToMatchAround SetupRelease { RateMatchPatternLTE-CRS }
OPTIONAL, -- Need M
    rateMatchPatternToAddModList SEQUENCE (SIZE (1..maxNrofRateMatchPatterns)) OF
RateMatchPattern  OPTIONAL, -- Need N
    rateMatchPatternToReleaseList SEQUENCE (SIZE (1..maxNrofRateMatchPatterns)) OF
RateMatchPatternld OPTIONAL, -- Need N
    ssbSubcarrierSpacing SubcarrierSpacing
OPTIONAL, -- Cond HOAndServCellWithSSB
    tdd-UL-DL-ConfigurationCommon TDD-UL-DL-ConfigCommon
OPTIONAL, -- Cond TDD
    ss-PBCH-BlockPower INTEGER (−60..50),
    ...,
    [[
    channelAccessMode-r16 CHOICE {
        dynamic NULL,
        semiStatic SemiStaticChannelAccessConfig-r16
    }
OPTIONAL, -- Cond SharedSpectrum
    discoveryBurstWindowLength-r16 ENUMERATED {ms0dot5, ms1, ms2, ms3, ms4, ms5}
OPTIONAL, -- Need R
    ssb-PositionQCL-r16 SSB-PositionQCL-Relation-r16
OPTIONAL, -- Cond SharedSpectrum
    highSpeedConfig-r16 HighSpeedConfig-r16
OPTIONAL -- Need R
    ]],
    [[
    highSpeedConfig-v1700 HighSpeedConfig-v1700
OPTIONAL, -- Need R
    channelAccessMode2-r17 ENUMERATED {enabled}
OPTIONAL, -- Cond SharedSpectrum2
    discoveryBurstWindowLength-r17 ENUMERATED {ms0dot125, ms0dot25, ms0dot5,
ms0dot75, ms1, ms1dot25} OPTIONAL, -- Need R
    ssb-PositionQCL-r17 SSB-PositionQCL-Relation-r17
OPTIONAL, -- Cond SharedSpectrum2
    highSpeedConfigFR2-r17 HighSpeedConfigFR2-r17
OPTIONAL, -- Need R
    uplinkConfigCommon-v1700 UplinkConfigCommon-v1700
OPTIONAL, -- Need R
    ntn-Config-r17 NTN-Config-r17
OPTIONAL -- Need R
    ]],
    [[
    featurePriorities-r17 SEQUENCE {
        redCapPriority-r17 Feature Priority-r17
OPTIONAL, -- Need R
        slicingPriority-r17 Feature Priority-r17
OPTIONAL, -- Need R
        msg3-Repetitions-Priority-r17 Feature Priority-r17
OPTIONAL, -- Need R
        sdt-Priority-r17 FeaturePriority-r17
OPTIONAL -- Need R
    }
OPTIONAL -- Need R
    ]]
}
-- TAG-SERVINGCELLCONFIGCOMMON-STOP
-- ASN1STOP
```

In the above embodiments, field description of said IE may further be modified as follows:

ServingCellConfigCommon field descriptions

n-TimingAdvanceOffset
The N_TA-Offset to be applied for all uplink transmissions on this serving cell. If the field is
absent, the UE applies the value defined for the duplex mode and frequency range of this
serving cell. See TS 38.133 [14], table 7.1.2-2. If is n-TimingAdvanceOffset_TRP is
configured, the UE ignores this field.
n-TimingAdvanceOffset_TRP
The N_TA-Offset to be applied for all uplink transmission on the indicated TAG of this
serving cell. If the field is absent, the UE applies the value defined for the duplex mode and
frequency range of this serving cell. See TS 38.133 [14], table 7.1.2-2.

In the above embodiments, TRP_info uses TAG_Id as an identifier, and according to the embodiments of the present disclosure, a downlink reference signal (group)/an RACH resource (group)/an RA preamble (group)/a CORESET/a CORESETPool/a PCI (group) information different from a PCI of a serving cell, etc. may be further used.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, the network device configures values of one or two timing advance offsets via one parameter (a first parameter), so that a serving cell is associated with values of two timing advance offsets, that is, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

### EMBODIMENTS OF A SECOND ASPECT

Embodiments of the present disclosure provide a method for determining a timing advance offset, which described from a terminal equipment side, the contents same as the embodiments of the first aspect are not repeated again.

FIG. 4 is a schematic diagram of a method for determining a timing advance offset in the embodiments of the present disclosure. Please refer to FIG. 4, the method includes:
401: a terminal equipment receives first information, the first information being used for configuring a first parameter, the first parameter including values of one or two timing advance offsets of one serving cell, the serving cell being associated with values of two timing advance offsets; and
402: the terminal equipment determines a timing advance offset of uplink transmission according to the first parameter.

It should be noted that the above FIG. 4 only schematically describes the embodiments of the present disclosure, but the present disclosure is not limited to this. For example, an execution step of each operation may be adjusted appropriately, moreover some other operations may be increased or operations therein may be reduced. Persons skilled in the art may make appropriate modifications according to the above contents, not limited to the records in the above FIG. 4.

According to the above embodiments, the network device configures value(s) of one or two timing advance offsets via one parameter (a first parameter), so that the serving cell is associated with values of the two timing advance offsets. That is, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

In the embodiments of the present disclosure, there are no restrictions on implementation of the first information. For example, the first information may be broadcast signaling or may be RRC dedicated signaling. That is, a network device may configure the first parameter via the broadcast signaling or the RRC dedicated signaling. The broadcast signaling e.g., is SIB1, and the first parameter e.g. is included in IE ServingCellConfigCommonSIB of SIB1. The RRC dedicated signaling e.g., is RRCReconfiguration, and the first parameter e.g. is included in IE ServingCellConfigCommon of RRCReconfiguration. The above are only examples for description, the present disclosure is not limited to this.

In the embodiments of the present disclosure, meanings of “the first parameter includes a value of one timing advance offset of one serving cell”, “the first parameter includes a value of one timing advance offset of one serving cell, the serving cell being associated with values of two timing advance offsets” and “the first parameter includes values of two timing advance offsets of one serving cell” and “the first parameter includes values of two timing advance offsets of one serving cell, the serving cell being associated with values of two timing advance offsets” have been described in the embodiments of the first aspect, their contents are incorporated here and are not elaborated here.

In some embodiments, the uplink transmission may be uplink transmission in a random access procedure, such as a random access preamble, message 3, message A (MSGA), etc.

In the above embodiments, the random access procedure may be at least one of the following:
a random access procedure executed on random access resources associated with a group of downlink reference signals;
a random access procedure executed on a group of random access channel (RACH) resources;
a random access procedure for transmitting a group of random access (RA) preambles;
a random access procedure triggered or scheduled by a PDCCH of a control resource set (CORESET) or a control resource set pool (CORESETPool);
a random access procedure for obtaining TA in a timing advance group (TAG); and
a random access procedure associated with a PCI different from a PCI of the serving cell.

The above random access procedures are only examples for description, the present disclosure is not limited to this.

In the above embodiments, the uplink transmission may be transmitted with a first time earlier than frame timing of downlink transmission, the first time may be a product of the value of the timing advance offset and a predetermined value Tc. That is, the uplink transmission is transmitted with a first time earlier than frame timing of downlink transmission by “the first parameter×Tc”.

In the above embodiments, the downlink transmission may be one or a group of downlink reference signals, or may be a PDCCH of a CORESET or CORESETPool, or may be a downlink carrier in a TAG, or any combination thereof. The present disclosure is not limited to this.

In some embodiments, the uplink transmission is at least one of the following:
all uplink transmissions corresponding to one or a group of downlink reference signals;
all uplink transmissions on one or a group of physical random access channel (PRACH) resources;
all uplink transmissions corresponding to one or a group of random access (RA) preambles;
all uplink transmissions scheduled by a PDCCH of a control resource set (CORESET) or a control resource set pool (CORESETPool); and
all uplink transmissions in a timing advance group (TAG).

In the above embodiments, the uplink transmission may be transmitted with a second time earlier than a last uplink transmission, the second time being a product of a sum of the value of the timing advance offset and a TA value and a predetermined value Tc. That is, the uplink transmission is transmitted earlier than a last uplink transmission by “(a first parameter+a TA value)×Tc”.

In the above embodiments, the TA value may be provided by a TAC (timing advance command) MAC CE (media access control control element) or by an absolute TAC MAC CE, or the TA value may be provided by an RAR (random access response) or MSGB (message B). The present application does not make limitations in this regard.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, the network device configures values of one or two timing advance offsets via one parameter (a first parameter), so that a serving cell is associated with values of two timing advance offsets, that is, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

### EMBODIMENTS OF A THIRD ASPECT

Embodiments of the present disclosure provide an apparatus for configuring a timing advance offset. The apparatus may, for example, be a network device, or may be one or more parts or components configured in the network device. The principle of the apparatus to solve the problem is same as the method in the embodiments of the first aspect, thus its specific implementation can refer to the implementation of the method in the embodiments of the first aspect, the same contents will not be repeated.

FIG. 5 is a schematic diagram of an apparatus for configuring a timing advance offset in the embodiments of the present disclosure. As shown in FIG. 5, the apparatus 500 for configuring a timing advance offset comprises:
a transmitting unit 501 configured to transmit first information to a terminal equipment, the first information being used for configuring a first parameter, the first parameter including values of one or two timing advance offsets of one serving cell, the serving cell being associated with values of two timing advance offsets.

In some embodiments, the serving cell is associated with at least one of the following: multiple groups of downlink reference signals;
multiple groups of random access channel (RACH) resources;
multiple groups of random access (RA) preambles;
multiple control resource set pools (CORESETPools);
multiple timing advance groups (TAGs);
multiple physical cell identifiers (PCIs) different from a PCI of the serving cell.

In some embodiments, one of the multiple PCIs different from the PCI of the serving cell is associated with at least one of the following:
one or a group of downlink reference signals;
one or a group of random access channel (RACH) resources;
one or a group of random access (RA) preambles;
a control resource set (CORESET);
a control resource set pool (CORESETPool); and
a timing advance group (TAG).

In some embodiments, that the first parameter includes a value of one timing advance offset of one serving cell comprises that, the first parameter includes a value of a first timing advance offset, and the first parameter or the first timing advance offset is associated with at least one of the following:
a group of downlink reference signals;
a group of random access channel (RACH) resources;
a group of random access (RA) preambles;
a control resource set pool (CORESETPool);
a control resource set (CORESET);
a timing advance group (TAG); and
a physical cell identifier (PCI) or a group of physical cell identifiers.

In the above embodiments, that the first parameter or the first timing advance offset is associated with a group of downlink reference signals may comprise that, information of the downlink reference signals and/or group information of the downlink reference signals is a part of the first parameter; or, a configuration of the downlink reference signals or a configuration of the group of downlink reference signal includes or is associated with the first parameter or a value of the first timing offset.

In the above embodiments, that the first parameter or the first timing advance offset is associated with a group of RACH resources may comprise that, information of the RACH resources and/or group information of the RACH resources is a part of the first parameter; or, a configuration of the RACH resources or a configuration of the group of RACH resources includes or is associated with the first parameter or a value of the first timing offset.

In the above embodiments, that the first parameter or the first timing advance offset is associated with a group of RA preambles may comprise that, information of the RA preambles and/or group information of the RA preambles is a part of the first parameter; or, a configuration of the RA preambles or a configuration of the group of RA preambles includes or is associated with the first parameter or a value of the first timing offset.

In the above embodiments, that the first parameter or the first timing advance offset is associated with a CORESETPool may comprise that, information of the CORESETPool is a part of the first parameter; or a configuration of the CORESETPool includes or is associated with the first parameter or a value of the first timing advance offset.

In the above embodiments, that the first parameter or the first timing advance offset is associated with a CORESET may comprise that, information of the CORESET is a part of the first parameter; or a configuration of the CORESET includes or is associated with the first parameter or a value of the first timing advance offset.

In the above embodiments, that the first parameter or the first timing advance offset is associated with a TAG may comprise that, ID of the TAG is a part of the first parameter; or a configuration of the TAG includes or is associated with the first parameter or a value of the first timing advance offset.

In the above embodiments, that the first parameter or the first timing advance offset is associated with a PCI or a group of PCIs may comprise that, the PCI is a part of the first parameter; or a configuration of a synchronization signal block (SSB) associated with the PCI or a configuration of the PCI includes or is associated with the first parameter or a value of the first timing advance offset.

In the above embodiments, the first information may further configure a second parameter, the second parameter including a value of a second timing advance offset, and the second parameter or the second timing advance offset is associated with at least one of the following: a group of downlink reference signals that are default or not associated with the first parameter;
a group of random access channel (RACH) resources that are default or not associated with the first parameter;
a group of random access (RA) preambles that are default or not associated with the first parameter;
a control resource set pool (CORESETPool) that is default or not associated with the first parameter;
a control resource set (CORESET) that is default or not associated with the first parameter;
a timing advance group (TAG) that is default or not associated with the first parameter; and
a physical cell identifier (PCI) or a group of PCIs that is/are default or not associated with the first parameter.

In some embodiments, that the first parameter includes a value of one timing advance offset of one serving cell, the serving cell being associated with values of two timing advance offsets, comprises that, the first parameter includes a value of a first timing advance offset, the second parameter includes a value of a second timing advance offset, the serving cell is associated with the value of the first timing advance offset and the value of the second timing advance offset.

In some embodiments, that the first parameter includes values of two timing advance offsets of one serving cell comprises that, the first parameter includes a value of a first timing advance offset and a value of a second timing advance offset, and the first parameter is associated with at least one of the following, or the first timing advance offset and the second timing advance offset are associated with at least one of the following:
two groups of downlink reference signals;
two groups of random access channel (RACH) resources;
two groups of random access (RA) preambles;
two control resource set pools (CORESETPools);
two control resource sets (CORESETs);
two timing advance groups (TAGs); and
two or two groups of physical cell identifiers (PCIs).

In the above embodiments, that the first parameter or the first timing advance offset and the second timing advance offset are associated with two groups of downlink reference signals may comprise that, information of the downlink reference signals and/or group information of the downlink reference signals is a part of the first parameter; or, a configuration of the downlink reference signals or a configuration of the group of downlink reference signals includes or is associated with the first parameter or includes or is associated with a value of the first timing offset and a value of the second timing advance offset.

In the above embodiments, that the first parameter or the first timing advance offset and the second timing advance offset are associated with two groups of RACH resources may comprise that, information of the RACH resources and/or group information of the RACH resources is a part of the first parameter; or, a configuration of the RACH resources or a configuration of the group of RACH resources includes or is associated with the first parameter or includes or is associated with a value of the first timing offset and a value of the second timing advance offset.

In the above embodiments, that the first parameter or the first timing advance offset and the second timing advance offset are associated with two groups of RA preambles may comprise that, information of the RA preambles and/or group information of the RA preambles is a part of the first parameter; or, a configuration of the RA preambles or a configuration of the group of RA preambles includes or is associated with the first parameter or includes or is associated with a value of the first timing offset and a value of the second timing advance offset.

In the above embodiments, that the first parameter or the first timing advance offset and the second timing advance offset are associated with two CORESETPools may comprise that, information of the CORESETPools is a part of the first parameter; or, a configuration of the CORESETPools includes or is associated with the first parameter or includes or is associated with a value of the first timing offset and a value of the second timing advance offset.

In the above embodiments, that the first parameter or the first timing advance offset and the second timing advance offset are associated with two CORESETs may comprise that, information of the CORESETs is a part of the first parameter; or, a configuration of the CORESETs includes or is associated with the first parameter or includes or is associated with a value of the first timing offset and a value of the second timing advance offset.

In the above embodiments, that the first parameter or the first timing advance offset and the second timing advance offset are associated with two TAGs comprises that, ID of the TAGs is a part of the first parameter; or, a configuration of the TAGs includes or is associated with the first parameter or includes or is associated with a value of the first timing offset and a value of the second timing advance offset.

In the above embodiments, that the first parameter or the first timing advance offset and the second timing advance offset are associated with two PCIs comprises that, PCIs are a part of the first parameter; or, a configuration of a synchronization signal block (SSB) or an additional PCI configuration includes or is associated with the first parameter or includes or is associated with a value of the first timing offset and a value of the second timing advance offset.

In some embodiments, that the first parameter includes values of two timing advance offsets of one serving cell, the serving cell being associated with values of two timing advance offsets, comprises that, the first parameter includes a value of a first timing advance offset and a value of a second timing advance offset, the serving cell is associated with the value of the first timing advance offset and the value of the second timing advance offset.

In some embodiments, the first information is broadcast signaling, or RRC dedicated signaling. The broadcast signaling e.g. is SIB 1, the first parameter is included in an information element ServingCellConfigCommonSIB of SIB 1; the RRC dedicated signaling e.g. is RRCReconfiguration, the first parameter is included in an information element ServingCellConfigCommon of RRCReconfiguration.

Embodiments of the present disclosure further provide an apparatus for determining a timing advance offset. The apparatus may, for example, be a terminal equipment, or may be one or more parts or components configured in the terminal equipment. The principle of the apparatus to solve the problem is same as the method in the embodiments of the second aspect, thus for its specific implementation, the implementation of the method in the embodiments of the second aspect may be referred to, the same contents will not be repeated.

FIG. 6 is another schematic diagram of an apparatus for determining a timing advance offset in the embodiments of the present disclosure. As shown in FIG. 6, the apparatus 600 for determining a timing advance offset comprises:
a receiving unit 601 configured to receive first information, the first information being used for configuring a first parameter, the first parameter including values of one or two timing advance offsets of one serving cell, the serving cell being associated with values of two timing advance offsets, and
a determining unit 602 configured to determine a timing advance offset of uplink transmission according to the first parameter.

In some embodiments, the uplink transmission is uplink transmission in a random access procedure.

In the above embodiments, the random access procedure may be at least one of the following:
a random access procedure executed on random access resources associated with a group of downlink reference signals;
a random access procedure executed on a group of random access channel (RACH) resources;
a random access procedure for transmitting a group of random access (RA) preambles;
a random access procedure triggered or scheduled by a PDCCH of a control resource set (CORESET) or a control resource set pool (CORESETPool);
a random access procedure for obtaining TA in a timing advance group (TAG); and
a random access procedure associated with a PCI different from a PCI of the serving cell.

In the above embodiment, the uplink transmission may be one of the following:
a random access preamble;
message 3;
message A (MSGA).

In the above embodiments, the uplink transmission is transmitted with a first time earlier than frame timing of downlink transmission, the first time being a product of the value of the timing advance offset and a predetermined value Tc.

In the above embodiment, the downlink transmission may be one of the following:
one or a group of downlink reference signals;
a PDCCH of a control resource set (CORESET) or a control resource set pool (CORESETPool); and
a downlink carrier in a timing advance group (TAG).

In some other embodiments, the uplink transmission is at least one of the following:
all uplink transmissions corresponding to one or a group of downlink reference signals;
all uplink transmissions on one or a group of physical random access channel (PRACH) resources;
all uplink transmissions corresponding to one or a group of random access (RA) preambles;
all uplink transmissions scheduled by a PDCCH of a control resource set (CORESET) or a control resource set pool (CORESETPool); and
all uplink transmissions in a timing advance group (TAG).

In the above embodiments, the uplink transmission is transmitted with a second time earlier than a last uplink transmission, the second time being a product of a sum of the value of the timing advance offset and a TA value and a predetermined value Tc.

In the above embodiments, the TA value is provided by a TAC MAC CE or by an absolute TAC MAC CE, or the TA value is provided by an RAR or MSGB.

It's worth noting that the above only describes components or modules related to the present disclosure, but the present disclosure is not limited to this. The apparatuses 500 and 600 in the embodiments of the present disclosure may further comprise other components or modules. For detailed contents of these components or modules, relevant technologies may be referred to.

Moreover, for the sake of simplicity, FIG. 5 and FIG. 6 only exemplarily show a connection relationship or signal direction between components or modules, however persons skilled in the art should know that various relevant technologies such as bus connection can be used. The above components or modules may be realized by a hardware facility such as a processor, a memory, a transmitter, a receiver, etc. The embodiments of the present disclosure have no limitation to this.

According to the apparatuses in the embodiments of the present disclosure, the network device configures values of one or two timing advance offsets via one parameter (a first parameter), so that a serving cell is associated with values of two timing advance offsets, that is, the network device provides values of two timing advance offsets associated with the serving cell to a terminal equipment, a value of each timing advance offset is applicable to different TRPs, in this way, the terminal equipment calculates uplink timing on different TRPs respectively based on each value, thereby UL synchronization on two TRPs of the terminal equipment is ensured, and the network device is able to correctly receive UL transmission (uplink transmission) of this terminal from the two TRPs and avoid interference with UL transmission of other terminal, improving network throughput and enhancing user experience.

### EMBODIMENTS OF A FOURTH ASPECT

Embodiments of the present disclosure provide a communication system, comprising a terminal equipment and a network device, the network device is configured to perform the method described in the embodiments of the first aspect, and the terminal equipment is configured to perform the method described in the embodiments of the second aspect. Behaviors of the network device and the terminal equipment have been described in detail in the embodiments of the first and second aspects, whose contents are incorporated here and will not be repeated here.

Embodiments of the present disclosure further provide a terminal equipment, comprising a memory and a processor, the memory storing a computer program, and the processor being configured to perform the computer program to implement the method described in the embodiments of the second aspect.

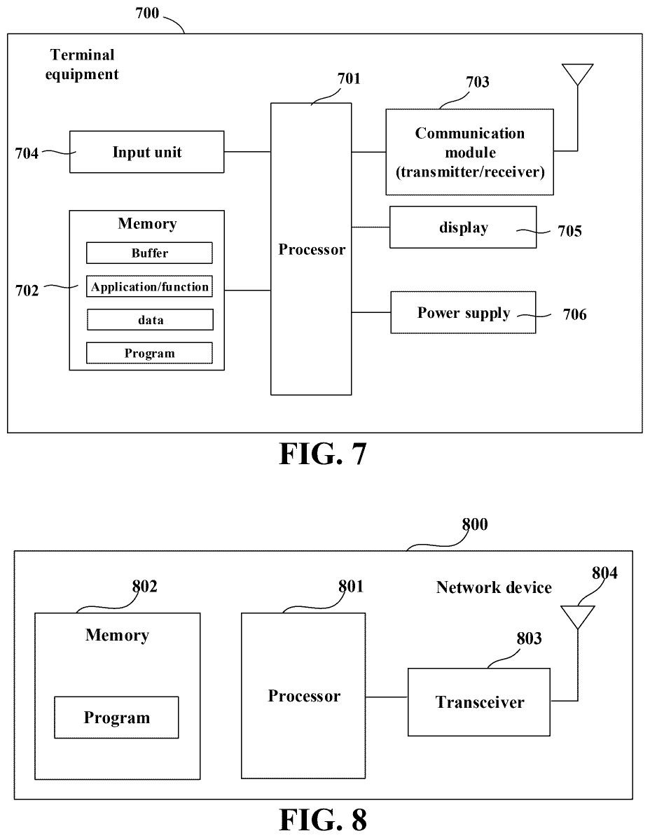

FIG. 7 is a schematic diagram of a terminal equipment in the embodiments of the present disclosure. As shown in FIG. 7, the terminal equipment 700 may comprise a processor 701 and a memory 702; the memory 702 stores data and programs, and is coupled to the processor 701. It's worth noting that this figure is exemplary; other types of structures may also be used to supplement or replace this structure, so as to realize a telecommunication function or other functions.

For example, the processor 701 can be configured to execute a program to implement the method as described in the embodiments of the second aspect.

As shown in FIG. 7, the terminal equipment 700 may further comprise: a communication module 703, an input unit 704, a display 705 and a power supply 706. The functions of said components are similar to related arts, which are not repeated here. It's worth noting that the terminal equipment 700 does not have to include all the components shown in FIG. 7, said components are not indispensable. Moreover, the terminal equipment 700 may further include components not shown in FIG. 7, related arts may be referred to.

Embodiments of the present disclosure further provide a network device, comprising a memory and a processor, the memory storing a computer program, and the processor being configured to perform the computer program to implement the method described in the embodiments of the first aspect.

FIG. 8 is a schematic diagram of a network device in the embodiments of the present disclosure. As shown in FIG. 8, the network device 800 may comprise: a central processing unit (CPU) 801 and a memory 802; the memory 802 is coupled to the central processing unit 801. The memory 802 may store various data; moreover, also stores a program for information processing, and executes the program under the control of the processor 801, so as to receive various information transmitted by the terminal equipment and transmit various information to the terminal equipment.

For example, the processor 801 may be configured to execute a program to implement the method as described in the embodiments of the first aspect.

In addition, as shown in FIG. 8, the network device 800 may further comprise: a transceiver 803 and an antenna 804, etc.; wherein the functions of said components are similar to relevant arts, which are not repeated here. It's worth noting that the network device 800 does not have to include all the components shown in FIG. 8. Moreover, the network device 800 may further comprise components not shown in FIG. 8, related arts may be referred to.

Embodiments of the present disclosure further provide a computer readable program, wherein when a terminal equipment executes the program, the program enables a computer to execute the method described in the embodiments of the second aspect, in the terminal equipment.

Embodiments of the present disclosure further provide a storage medium in which a computer readable program is stored, wherein the computer readable program enables a computer to execute the method as described in the embodiments of the second aspect, in a terminal equipment.

Embodiments of the present disclosure further provide a computer readable program, wherein when a network device executes the program, the program enables a computer to execute the method described in the embodiments of the first aspect, in the network device.

Embodiments of the present disclosure further provide a storage medium in which a computer readable program is stored, wherein the computer readable program enables a computer to execute the method as described in the embodiments of the first aspect, in a network device.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The logic component is e.g. a field programmable logic component, a microprocessor, a processor used in a computer, etc. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

Regarding the above implementations disclosed in this embodiment, the following supplements are further disclosed:

1. A method for configuring a timing advance offset, wherein the method includes:
a network device transmits first information to a terminal equipment, the first information being used for configuring a first parameter, the first parameter including values of one or two timing advance offsets of one serving cell, the serving cell being associated with values of two timing advance offsets.

2. The method according to Supplement 1, wherein, the serving cell is associated with at least one of the following:
multiple groups of downlink reference signals;
multiple groups of random access channel (RACH) resources;
multiple groups of random access (RA) preambles;
multiple control resource set pools (CORESETPools);
multiple timing advance groups (TAGs);
multiple physical cell identifiers (PCIs) different from a PCI of the serving cell.

3. The method according to Supplement 2, wherein, one of the multiple PCIs different from the PCI of the serving cell is associated with at least one of the following:
one or a group of downlink reference signals;
one or a group of random access channel (RACH) resources;
one or a group of random access (RA) preambles;
a control resource set (CORESET);
a control resource set pool (CORESETPool); and
a timing advance group (TAG).

4. The method according to Supplement 1, wherein that the first parameter includes a value of one timing advance offset of one serving cell comprises that:
the first parameter includes a value of a first timing advance offset, and the first parameter or the first timing advance offset is associated with at least one of the following:
a group of downlink reference signals;
a group of random access channel (RACH) resources;
a group of random access (RA) preambles;
a control resource set pool (CORESETPool);
a control resource set (CORESET);
a timing advance group (TAG); and
a physical cell identifier (PCI) or a group of physical cell identifiers.

4a. The method according to Supplement 4, wherein, that the first parameter or the first timing advance offset is associated with a group of downlink reference signals comprises that:
information of the downlink reference signals and/or group information of the downlink reference signals is a part of the first parameter; or
a configuration of the downlink reference signals or a configuration of the group of downlink reference signal includes or is associated with the first parameter or a value of the first timing advance offset.

4b. The method according to Supplement 4, wherein, that the first parameter or the first timing advance offset is associated with a group of RACH resources comprises that:
information of the RACH resources and/or group information of the RACH resources is a part of the first parameter; or
a configuration of the RACH resources or a configuration of the group of RACH resource includes or is associated with the first parameter or a value of the first timing advance offset.

4c. The method according to Supplement 4, wherein, that the first parameter or the first timing advance offset is associated with a group of RA preambles comprises that:
information of the RA preambles and/or group information of the RA preambles is a part of the first parameter; or
a configuration of the RA preambles or a configuration of the group of RA preamble includes or is associated with the first parameter or a value of the first timing advance offset.

4d. The method according to Supplement 4, wherein, that the first parameter or the first timing advance offset is associated with a CORESETPool comprises that:
information of the CORESETPool is a part of the first parameter; or
a configuration of the CORESETPool includes or is associated with the first parameter or a value of the first timing advance offset.

4e. The method according to Supplement 4, wherein, that the first parameter or the first timing advance offset is associated with a CORESET comprises that:
information of the CORESET is a part of the first parameter; or
a configuration of the CORESET includes or is associated with the first parameter or a value of the first timing advance offset.

4f. The method according to Supplement 4, wherein, that the first parameter or the first timing advance offset is associated with a TAG comprises that:
ID of the TAG is a part of the first parameter; or
a configuration of the TAG includes or is associated with the first parameter or a value of the first timing advance offset.

4g. The method according to Supplement 4, wherein, that the first parameter or the first timing advance offset is associated with a PCI or a group of PCIs comprises that:
the PCI is a part of the first parameter; or
a configuration of a synchronization signal block (SSB) associated with the PCI or a configuration of the PCI includes or is associated with the first parameter or a value of the first timing advance offset.

5. The method according to Supplement 4, wherein, the first information is further used to configure a second parameter, the second parameter including a value of a second timing advance offset, and the second parameter or the second timing advance offset is associated with at least one of the following:
a group of downlink reference signals that are default or not associated with the first parameter;
a group of random access channel (RACH) resources that are default or not associated with the first parameter;
a group of random access (RA) preambles that are default or not associated with the first parameter;
a control resource set pool (CORESETPool) that is default or not associated with the first parameter;
a control resource set (CORESET) that is default or not associated with the first parameter;
a timing advance group (TAG) that is default or not associated with the first parameter; and
a physical cell identifier (PCI) or a group of PCIs that is/are default or not associated with the first parameter.

6. The method according to Supplement 1 or 4 or 5, wherein that the first parameter includes a value of one timing advance offset of one serving cell, the serving cell being associated with values of two timing advance offsets, comprises that:
the first parameter includes a value of the first timing advance offset, the second parameter includes a value of the second timing advance offset, and the serving cell is associated with the value of the first timing advance offset and the value of the second timing advance offset.

7. The method according to Supplement 1, wherein that the first parameter includes values of two timing advance offsets of one serving cell comprises that:
the first parameter includes a value of a first timing advance offset and a value of a second timing advance offset, and the first parameter is associated with at least one of the following, or the first timing advance offset and the second timing advance offset are associated with at least one of the following:
two groups of downlink reference signals;
two groups of random access channel (RACH) resources;
two groups of random access (RA) preambles;
two control resource set pools (CORESETPools);
two control resource sets (CORESETs);
two timing advance groups (TAGs); and
two or two groups of physical cell identifiers (PCIs).

7a. The method according to Supplement 7, wherein, that the first parameter or the first timing advance offset and the second timing advance offset are associated with two groups of downlink reference signals comprises that:
information of the downlink reference signals and/or group information of the downlink reference signals is a part of the first parameter; or
a configuration of the downlink reference signals or a configuration of the group of downlink reference signals includes or is associated with the first parameter or includes or is associated with a value of the first timing advance offset and a value of the second timing advance offset.

7b. The method according to Supplement 7, wherein, that the first parameter or the first timing advance offset and the second timing advance offset are associated with two groups of RACH resources comprises that:
information of the RACH resources and/or group information of the RACH resources is a part of the first parameter; or
a configuration of the RACH resources or a configuration of the group of RACH resource includes or is associated with the first parameter or includes or is associated with a value of the first timing advance offset and a value of the second timing advance offset.

7c. The method according to Supplement 7, wherein, that the first parameter or the first timing advance offset and the second timing advance offset are associated with two groups of RA preambles comprises that:
information of the RA preambles and/or group information of the RA preambles is a part of the first parameter; or
a configuration of the RA preambles or a configuration of the group of RA preamble includes or is associated with the first parameter or includes or is associated with a value of the first timing advance offset and a value of the second timing advance offset.

7d. The method according to Supplement 7, wherein, that the first parameter or the first timing advance offset and the second timing advance offset are associated with two CORESETPools comprises that:
information of the CORESETPool is a part of the first parameter; or
a configuration of the CORESETPool includes or is associated with the first parameter or includes or is associated with a value of the first timing advance offset and a value of the second timing advance offset.

7e. The method according to Supplement 7, wherein, that the first parameter or the first timing advance offset and the second timing advance offset are associated with two CORESETs comprises that:
information of the CORESETs is a part of the first parameter; or
a configuration of the CORESETs includes or is associated with the first parameter or includes or is associated with a value of the first timing advance offset and a value of the second timing advance offset.

7f. The method according to Supplement 7, wherein, that the first parameter or the first timing advance offset and the second timing advance offset are associated with two TAGs comprises that:
ID of the TAG is a part of the first parameter; or
a configuration of the TAGs includes or is associated with the first parameter or includes or is associated with a value of the first timing advance offset and a value of the second timing advance offset.

7g. The method according to Supplement 7, wherein, that the first parameter or the first timing advance offset and the second timing advance offset are associated with two PCIs comprises that:
the PCI is a part of the first parameter; or
a synchronization signal block (SSB) configuration or an additional PCI configuration includes or is associated with the first parameter or includes or is associated with a value of the first timing advance offset and a value of the second timing advance offset.

8. The method according to Supplement 1 or 7, wherein that the first parameter includes values of two timing advance offsets of one serving cell, the serving cell being associated with values of two timing advance offsets, comprises that:
the first parameter includes a value of the first timing advance offset and a value of the second timing advance offset, and the serving cell is associated with the value of the first timing advance offset and the value of the second timing advance offset.

9. The method according to any one of Supplements 1 to 8, wherein,
the first parameter is contained in broadcast signaling or in RRC dedicated signaling.

10. The method according to Supplement 9, wherein,
the broadcast signaling is SIB 1, and the first parameter is contained in an information element ServingCellConfigCommonSIB of the SIB 1; and
the RRC dedicated signaling is RRCReconfiguration, and the first parameter is contained in an information element ServingCellConfigCommon of the RRCReconfiguration.

11. A method for determining a timing advance offset, wherein the method includes:
a terminal equipment receives first information, the first information being used for configuring a first parameter, the first parameter including values of one or two timing advance offsets of one serving cell, the serving cell being associated with values of two timing advance offsets; and
the terminal equipment determines a timing advance offset of uplink transmission according to the first parameter.

12. The method according to Supplement 11, wherein,
the uplink transmission is uplink transmission in a random access procedure.

13. The method according to Supplement 12, wherein, the random access procedure is at least one of the following:
a random access procedure executed on random access resources associated with a group of downlink reference signals;
a random access procedure executed on a group of random access channel (RACH) resources;
a random access procedure for transmitting a group of random access (RA) preambles;
a random access procedure triggered or scheduled by a PDCCH of a control resource set (CORESET) or a control resource set pool (CORESETPool);
a random access procedure for obtaining TA in a timing advance group (TAG); and
a random access procedure associated with a PCI different from a PCI of the serving cell.

14. The method according to Supplement 12, wherein, the uplink transmission is one of the following:
a random access preamble;
message 3;
message A (MSGA).

15. The method according to any one of Supplements 12 to 14, wherein,
the uplink transmission is transmitted with a first time earlier than frame timing of downlink transmission, the first time being a product of the value of the timing advance offset and a predetermined value Tc.

16. The method according to Supplement 15, wherein, the downlink transmission is one of the following:
one or a group of downlink reference signals;
a PDCCH of a control resource set (CORESET) or a control resource set pool (CORESETPool); and
a downlink carrier in a timing advance group (TAG).

17. The method according to Supplement 11, wherein, the uplink transmission is at least one of the following:
all uplink transmissions corresponding to one or a group of downlink reference signals;
all uplink transmissions on one or a group of physical random access channel (PRACH) resources;
all uplink transmissions corresponding to one or a group of random access (RA) preambles;
all uplink transmissions scheduled by a PDCCH of a control resource set (CORESET) or a control resource set pool (CORESETPool); and
all uplink transmissions in a timing advance group (TAG).

18. The method according to Supplement 17, wherein,
the uplink transmission is transmitted with a second time earlier than a last uplink transmission, the second time being a product of a sum of the value of the timing advance offset and a TA value and a predetermined value Tc.

19. The method according to Supplement 18, wherein,
the TA value is provided by a TAC MAC CE or by an absolute TAC MAC CE, or
the TA value is provided by an RAR or MSGB.

20. A terminal equipment, comprising a memory and a processor, the memory storing a computer program, and the processor being configured to execute the computer program to implement the method according to any one of Supplements 11 to 19.

21. A network device, comprising a memory and a processor, the memory storing a computer program, and the processor being configured to execute the method according to any one of Supplements 1 to 10.

22. A communication system, comprising a terminal equipment and a network device, the terminal equipment being configured to execute the method according to any one of Supplements 11 to 19, and/or, the network device being configured to execute the method according to any one of Supplements 1 to 10.

1. An apparatus, configured in a network device, comprising:
a memory;
processor circuitry coupled to the memory; and
a transmitter configured to transmit first information to a terminal equipment, the first information being used for configuring a first parameter and a second parameter, the first parameter including a value of a first timing advance offset of a severing cell, the second parameter including a value of a second timing advance offset, and the serving cell being associated with the value of the first timing advance offset and the value of the second timing advance offset;
wherein the first parameter or the first timing advance offset is associated with at least one of the following:
a control resource set (CORESET);
a timing advance group (TAG); and
a physical cell identifier (PCI).

2. The apparatus according to claim 1, wherein, the serving cell is associated with at least one of the following:
multiple groups of downlink reference signals;
multiple groups of random access channel (RACH) resources;
multiple groups of random access (RA) preambles;
multiple control resource set pools (CORESETPools);
multiple timing advance groups (TAGs);
multiple physical cell identifiers (PCIs) different from a PCI of the serving cell.

3. The apparatus according to claim 2, wherein, one of the multiple PCIs different from the PCI of the serving cell is associated with at least one of the following:
one or a group of downlink reference signals;
one or a group of random access channel (RACH) resources;
one or a group of random access (RA) preambles;
a control resource set (CORESET);
a control resource set pool (CORESETPool); and
a timing advance group (TAG).

4. The apparatus according to claim 1, wherein the first parameter or the first timing advance offset is further associated with at least one of the following:
a group of downlink reference signals;
a group of random access channel (RACH) resources;
a group of random access (RA) preambles;
a control resource set pool (CORESETPool); and
a group of physical cell identifiers.

5. The apparatus according to claim 4, wherein the second parameter or the second timing advance offset is associated with at least one of the following:
a group of downlink reference signals that are default or not associated with the first parameter;
a group of random access channel (RACH) resources that are default or not associated with the first parameter;
a group of random access (RA) preambles that are default or not associated with the first parameter;
a control resource set pool (CORESETPool) that is default or not associated with the first parameter;
a control resource set (CORESET) that is default or not associated with the first parameter;
a timing advance group (TAG) that is default or not associated with the first parameter; and
a physical cell identifier (PCI) or a group of PCIs that is/are default or not associated with the first parameter.

6. The apparatus according to claim 1, wherein,
the first parameter is contained in broadcast signaling or in radio resource control (RRC) dedicated signaling.

7. The apparatus according to claim 6, wherein,
the broadcast signaling is SIB 1, and the first parameter is contained in an information element ServingCellConfigCommonSIB of the SIB 1; and
the RRC dedicated signaling is RRCReconfiguration, and the first parameter is contained in an information element ServingCellConfigCommon of the RRCReconfiguration.

8. An apparatus for determining a timing advance offset, the apparatus comprising:
a receiver configured to receive first information, the first information being used for configuring a first parameter and a second parameter, the first parameter including a value of a first timing advance offsets of a serving cell, the second parameter including a value of a second timing advance offset, and the serving cell being associated with the value of the first timing advance offset and the value of the second timing advance offset, and
processor circuitry configured to determine a timing advance offset of uplink transmission according to the first parameter,
wherein the first parameter or the first timing advance offset is associated with at least one of the following:
a control resource set (CORESET);
a timing advance group (TAG); and
a physical cell identifier (PCI).

9. The apparatus according to claim 8, wherein,
the uplink transmission is uplink transmission in a random access procedure.

10. The apparatus according to claim 9, wherein, the random access procedure is at least one of the following:
a random access procedure executed on random access resources associated with a group of downlink reference signals;
a random access procedure executed on a group of random access channel (RACH) resources;
a random access procedure for transmitting a group of random access (RA) preambles;
a random access procedure triggered or scheduled by a physical downlink control channel (PDCCH) of a control resource set (CORESET) or a control resource set pool (CORESETPool);
a random access procedure for obtaining timing advance (TA) in a timing advance group (TAG); and
a random access procedure associated with a PCI different from a PCI of the serving cell.

11. The apparatus according to claim 9, wherein, the uplink transmission is one of the following:
a random access preamble;
message 3;
message A (MSGA).

12. The apparatus according to claim 9, wherein,
the uplink transmission is transmitted with a first time earlier than frame timing of downlink transmission, the first time being a product of the value of the timing advance offset and a predetermined value Tc.

13. The apparatus according to claim 12, wherein, the downlink transmission is one of the following:
one or a group of downlink reference signals;
a physical downlink control channel (PDCCH) of a control resource set (CORESET) or a control resource set pool (CORESETPool); and
a downlink carrier in a timing advance group (TAG).

14. The apparatus according to claim 8, wherein, the uplink transmission is at least one of the following:
all uplink transmissions corresponding to one or a group of downlink reference signals;
all uplink transmissions on one or a group of physical random access channel (PRACH) resources;
all uplink transmissions corresponding to one or a group of random access (RA) preambles;
all uplink transmissions scheduled by a PDCCH of the control resource set (CORESET) or a control resource set pool (CORESETPool); and
all uplink transmissions in the timing advance group (TAG).

15. The apparatus according to claim 14, wherein,
the uplink transmission is transmitted with a second time earlier than a last uplink transmission, the second time being a product of a sum of the value of the timing advance offset and a TA value and a predetermined value Tc.

16. The apparatus according to claim 15, wherein,
the TA value is provided by a timing advance command (TAC) media access control (MAC) control element (CE) or an absolute TAC MAC CE, or
the TA value is provided by a random access response (RAR) or message B (MSGB).

17. A communication system, comprising:
a terminal equipment; and
a network device,
wherein,
the network device is configured to transmit first information to the terminal equipment, the first information being used for configuring a first parameter and a second parameter, the first parameter including a value of a first timing advance offset of a serving cell, the second parameter including a value of a second timing advance offset, and the serving cell being associated with the value of the first timing advance offset and the value of the second timing advance offset; and
the terminal equipment is configured to receive the first information, and determine a timing advance offset of uplink transmission according to the first parameter;
wherein the first parameter or the first timing advance offset is associated with at least one of the following:
a control resource set (CORESET);
a timing advance group (TAG); and
a physical cell identifier (PCI).
